(19) United States
(12) Patent Application Publication
(10) Pub. No.: US 2024/0297899 A1
(43) Pub. Date: Sep. 5, 2024

(54) TECHNIQUES FOR ACCURATE LEARNING OF BASELINES FOR CHARACTERIZING ADVANCED APPLICATION-LAYER FLOOD ATTACK TOOLS

(71) Applicant: Radware Ltd., Tel Aviv (IL)

(72) Inventors: Ehud DORON, Moddi'in (IL); Alon TAMIR, Kiryat Ono (IL); David AVIV, Tel Aviv (IL)

(73) Assignee: Radware Ltd., Tel Aviv (IL)

(21) Appl. No.: 18/398,985

(22) Filed: Dec. 28, 2023

Related U.S. Application Data
(63) Continuation-in-part of application No. 18/176,667, filed on Mar. 1, 2023.
(60) Provisional application No. 63/477,522, filed on Dec. 28, 2022.

(51) Int. Cl. H04L 9/40

(52) U.S. Cl. CPC H04L 63/1458; H04L 63/168

(57) ABSTRACT

A system and method for learning attack-safe baselines are provided. The method includes receiving application-layer transactions directed to a protected entity; measuring values of a rate-based attribute and a rate-invariant attribute from the received application-layer transactions; determining, based on the measured rate-based attribute, if the received application-layer transactions represent a normal behavior; computing at least one baseline using application-layer transactions determined to represent the normal behavior; validating the at least one computed baseline using the measured rate-invariant attribute and rate-based attribute; and building a set of baselines based on the at least one validated baseline, wherein the set of baselines are utilized for characterization of DDoS attacks.

### CROSS-REFERENCE TO RELATED APPLICATIONS

The present application is a continuation in part of U.S. patent application Ser. No. 18/176,667, filed on Mar. 1, 2023, which claims the benefit of U.S. Provisional Application No. 63/477,522 filed on Dec. 28, 2022, the contents of which are hereby incorporated by reference.

### TECHNICAL FIELD

This present disclosure generally relates to techniques for characterization of application-layer denial of service (DOS) based attacks, and specifically for generating application-layer signatures characterizing advanced application-layer flood attack tools.

### BACKGROUND

These days, online businesses and organizations are vulnerable to malicious attacks. Recently, cyber-attacks have been committed using a wide arsenal of attack techniques and tools targeting both the information maintained by online businesses, their IT infrastructure, and the actual service availability. Hackers and attackers are constantly trying to improve their attack strategies to cause irrecoverable damage, overcome currently deployed protection mechanisms, and so on.

One type of popular cyber-attack is a Denial of Service (“DoS”)/Distributed Denial of Service (“DDoS”) attack, which is an attempt to make a computer or network resource unavailable or idle. A common technique for executing DOS/DDoS attacks includes saturating a target victim resource (e.g., a computer, a WEB server, an API server, a WEB application, other type of applicative servers, and the like), with a large quantity of external applicative requests or volume of traffic. As a result, the target victim becomes overloaded, and thus cannot assign resources and respond properly to legitimate traffic or legitimate service requests. When the attacker sends many applicative or other requests towards its victim service or application, each victim resource would experience effects from the DOS attack. A DOS attack is performed by an attacker with a single machine, while a DDoS attack is performed by an attacker controlling many machines and other entities and directing them to attack as a group.

One type of DDoS attack is known as an “Application Layer DDoS Attack”. This is a form of a DDoS attack where attackers target application-layer processes, resources or the applications as a whole. The attack over-exercises specific functions or features of an application to disable those functions or features, and by that makes the application irresponsive to legitimate requests or even terminate or crash. A major sub-class of application layer DDoS attack is the HTTP flood attack.

In HTTP flood attacks, attackers send many manipulated HTTP GET and/or POST and/or other unwanted HTTP requests to attack, or to overload, a victim server, service, or application resources. These attacks are often executed by an attack tool, or tools, designed to generate and send floods of “legitimate like” HTTP requests to the victim server. The contents of such requests might be randomized, or pseudo-randomized, in order to emulate legitimate WEB client behavior and evade anti-DoS mitigation elements. Examples of such tools include Challenge Collapsar (CC), Shaphyra, Mirai botnet, Meris botnet, Blood, MHDDoS, DDoSIA, Akira, Xerxes, WEB stresser, DDoSers, and the like.

Recently, a large number of new and sophisticated tools have been developed by hackers and are now being used in various lethal and very high-volume HTTP flood attacks. The need for very simple and accurate solutions for HTTP floods attack mitigation is becoming actual and urgent. Modern on-line services demand for applicative anti-DoS solutions that are required to be able to characterize incoming HTTP requests as generated by attacker or by legit client, all in real-time, with very low false positive rate and very low false negative rate. Attackers keep on improving their attack tools by generating “legitimate like” HTTP requests, resulting in very challenging mitigation and more specific characterization of applicative attacks.

Accurate characterization of HTTP flood attacks executed by such tools is a complex problem that cannot be achieved by currently available solutions for mitigating DDoS attacks. Distinguishing legitimate HTTP requests from malicious HTTP requests is a complex and convoluted task. The complexity of the problem results from the fact that there are dozens of attack tools that behave differently and generate different attack patterns. Further, the attack tools send HTTP requests with a truly legitimate structure (e.g., a header and payload as defined in the respective HTTP standard and follow the industry common practices) and with some parts of their requests' contents being sophisticatedly randomized.

For example, the values of HTTP headers, query argument key and value, WEB Cookie and so on, can all be randomly selected. Furthermore, since the multitude of requests is high (e.g., thousands or tens of thousands of requests in each second) and there is an ever-evolving content of requests, along with the vast usage of randomization, existing DDoS mitigation solutions cannot efficiently and accurately characterize HTTP flood application layer DDoS attacks.

Existing detection solutions approaches are based on calculating the normal baseline during peacetime (when no attack is active or detected), and then any deviation from the baseline is detected as an attack. The baseline is a statistical model calculated or learned over received HTTP requests, representing a normal behavior of a legitimate client accessing the protected server. Upon HTTP flood attack detection, the normal baseline can potentially be used to the actual attacker characterization tasks.

There are major challenges with HTTP flood mitigation solutions that are based on legitimate normal baselining for the purposes of attack characterization. One challenge is due to the ability to realize an accurate baseline on a legitimate non-stationary application or an application with a low rate and bursty traffic. Complementary, during an attack, it is challenging to realize fast and accurate learning the attacker's behavior and understand the attacker patterns needed for generating an accurate and efficient application-layer signature. These challenges are substantial when it is needed to establish application-layer signatures when the attack is carried out by the attacks generating ultra-high volume of random requests. In such cases, there is a relatively low probability that a specific attacker's pattern can be detected and mitigated.

Further, since HTTPS flood attacks employ legitimate-appearing requests with or without high volumes of traffic, and with numerous random patterns, it is difficult to differentiate such requests from valid legitimate traffic. Thus, such types of DDoS attacks are amongst the most advanced non-vulnerable security challenges facing WEB servers and applications owners today.

Therefore, in order to accurately and efficiently characterize an applicative attack tool there is an essential need to compute a unique baseline that accurately model the legitimate behavior of the legitimate clients accessing a protected server or application. As HTTP Flood attacks are becoming more frequent, security teams are facing significant challenges when it comes to allowing the learning period free from such attacks. This learning period is essential to start active and accurate mitigation. However, since applications are constantly attacked, the result is that the learning period is contaminated with attacker traffic, making it difficult to ensure accurate attack mitigation. Ironically, in such cases, legitimate traffic can also be characterized as an attack. In some cases, the learning process is even initiated during an active attack. This challenge can be seen as a “chicken and egg” problem. How can a mitigation system ensure safe learning against attacks when it lacks the prerequisites for characterizing attacks accurately? Further, there is a challenge with the current learning approaches which is the lack of means to ensure the quality of learning. It is uncertain whether the learning has concluded in a way that allows active attack mitigation to begin once all baselines accurately represent the legitimate normal application behavior.

It would be, therefore, advantageous to provide an efficient security solution for safeguarding the learning period needed for the purpose of accurate characterization of HTTP and HTTPS flood attacks.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” or “one aspect” or “some aspects” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include receiving application-layer transactions directed to a protected entity. Method may also include measuring values of a rate-based attribute and a rate-invariant attribute from the received application-layer transactions. Method may furthermore include determining, based on the measured rate-based attribute, if the received application-layer transactions represent a normal behavior. Method may in addition include computing at least one baseline using application-layer transactions determined to represent the normal behavior. Method may moreover include validating the at least one computed baseline using the measured rate-invariant attribute and rate-based attribute. Method may also include building a set of baselines based on the at least one validated baseline, where the set of baselines are utilized for characterization of DDoS attacks. Other embodiments of this aspect include corresponding computer systems, apparatus, and computer programs recorded on one or more computer storage devices, each configured to perform the actions of the methods.

In one general aspect, system may include one or more processors configured to: receive application-layer transactions directed to a protected entity; measure values of a rate-based attribute and a rate-invariant attribute from the received application-layer transactions; determine, based on the measured rate-based attribute, if the received application-layer transactions represent a normal behavior; compute at least one baseline using application-layer transactions determined to represent the normal behavior; validate the at least one computed baseline using the measured rate-invariant attribute and rate-based attribute; and build a set of baselines based on the at least one validated baseline, where the set of baselines are utilized for characterization of DDoS attacks. Other embodiments of this aspect include corresponding computer systems, apparatus, and computer programs recorded on one or more computer storage devices, each configured to perform the actions of the methods.

In one general aspect, non-transitory computer-readable medium may include one or more instructions that, when executed by one or more processors of a device, cause the device to: receive application-layer transactions directed to a protected entity; measure values of a rate-based attribute and a rate-invariant attribute from the received application-layer transactions; determine, based on the measured rate-based attribute, if the received application-layer transactions represent a normal behavior; compute at least one baseline using application-layer transactions determined to represent the normal behavior; validate the at least one computed baseline using the measured rate-invariant attribute and rate-based attribute; and build a set of baselines based on the at least one validated baseline, where the set of baselines are utilized for characterization of DDoS attacks. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram utilized to describe the various embodiments for characterization application-layer flood attacks according to some embodiments.

FIG. 2A is a flowchart illustrating the characterization of HTTP flood attacks according to an embodiment.

FIG. 2B is a flowchart illustrating the creation of window paraphrase buffers according to an embodiment.

FIG. 3 is an example structure paraphrase vector generated according to an embodiment.

FIG. 4 is a flowchart illustrating the process of generating a paraphrase vector according to an embodiment.

FIG. 5 is an array of paraphrase buffers generated according to an embodiment.

FIG. 6 is a flowchart illustrating a process for generating application-layer signatures characterizing advanced application-layer flood attack tools according to an embodiment.

FIG. 7 is a chart demonstrating the transformation from histograms to paraphrase distributions.

FIG. 8 is an example process used for an initial learning process to establish an initial baseline in accordance with an embodiment.

FIG. 9 is a flowchart of an example process for safeguarding a learning process to establish attack-safe baselines during the active learning period according to an embodiment.

FIG. 10 is a flowchart of an example process for determining if application-layer transactions represent a normal behavior according to the disclosed embodiments.

FIG. 11 shows an example graph demonstrating the process for safeguarding a baseline learning process.

FIG. 12 shows an example diagram of a state machine illustrating the process performed during the baseline learning period according to an embodiment.

FIG. 13 is a block diagram of a device utilized to carry the disclosed embodiments.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural, and vice versa, with no loss of generality. In the drawings, like numerals refer to like parts through several views.

The various disclosed embodiments include a method for baselining and characterization of HTTP flood DDoS attacks. The disclosed method characterizes malicious requests over legitimate requests, to dynamically generate signatures of the attack tools. The generated signatures may allow efficient mitigation of HTTP flood attacks. In an embodiment, the disclosed method can be performed by a device in an out-of-path or an in-line always-on deployment. The various disclosed embodiments will be described with reference to an HTTP flood DDoS attack, but the techniques disclosed herein can be utilized to characterize flood DDoS attacks generated by other types of application layer protocols.

As discussed herein, a signature of an attack tool is a subtraction of attack paraphrase distributions from baseline paraphrase distributions. Such distributions are determined or otherwise computed using paraphrase buffers. For the purpose of this disclosure and without limiting the scope of the disclosed embodiments, the following terms (either in their singular or plural form) are being utilized: a paraphrase; a paraphrase vector; a paraphrase buffer, which is a set of paraphrase values; paraphrase buffers, which are a set of paraphrase buffer; baseline paraphrase distribution; baseline paraphrase distributions, which are a set of baseline paraphrase distribution; attack paraphrase distribution; and attack paraphrase distributions, which are a set of attack paraphrase distribution. A paraphrase characterizes the structure of a layer-7 transaction (e.g., HTTP request). That is, a paraphrase maintains the attributes of an incoming transaction. Each paraphrase includes one or more paraphrase values. A paraphrase vector includes a set of paraphrases. The paraphrases are used to generate the required applicative (layer-7) signatures characterizing the attacker's applicative attributes for the purpose of attack mitigation.

As explained in more detail later, the application signatures are created using baselines learned during peacetime, i.e., when there are no active DDoS attacks. The embodiments disclosed herein are related to the baseline learning at a pre-operational state of the system. That is before the disclosed system can characterize and mitigate attacks. The “pre-operational” learning state may include an initial baseline learning as an active baseline learning. It is crucial that the learned baselines are accurate to enable effective and reliable identification of DDoS attacks applicative transactions. To this end, according to the disclosed embodiments, the learned baselines are attack-safe baselines. That is, during a pre-defined initial learning period, the traffic is monitored and processed to establish the normal baselines required for attacker characterization while ensuring that the learned traffic is legitimate client traffic and is not an attacker traffic. To this, during the initial learning period the disclosed embodiments are configured to receive application-layer transactions directed to a protected entity; measure values of a rate-based attribute and a rate-invariant attribute from the received application-layer transactions; determine, based on the measured rate-based attribute, if the received application-layer transactions represent a normal behavior; compute the required baselines using application-layer transactions determined to represent the normal behavior; and at the end of the learning period validate the computed baseline using the measured rate-invariant attribute and rate-based attribute. Thus, the disclosed embodiments allow for establishing accurate attack-safe baselines and, therefore, ensure accurate characterization of attacks with fewer false positive and false negative alerts.

According to the disclosed embodiments, the attack-safe baselines are established prior to initiating any attack detection and mitigation. Thus, the learning of such baselines can be determined as pre-operation of the system disclosed herein. The attack-safe baselines, once established, are continuously updated during the detection of attacks, hence the operation of the disclosed system.

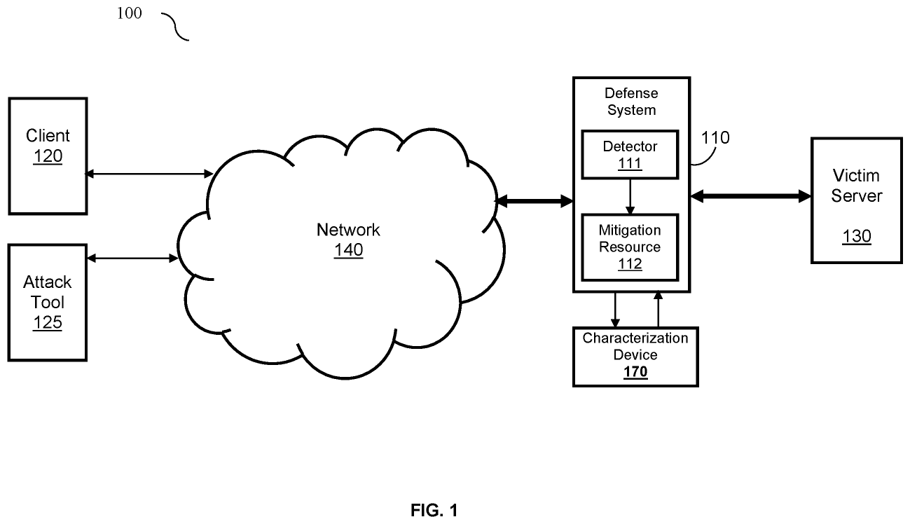

FIG. 1 is a schematic diagram 100 utilized to describe the various embodiments for characterization and mitigate HTTP flood attacks according to some embodiments. In schematic diagram 100, client devices 120 and 125 communicate with a victim server (or simply a server) 130 over a network 140. To demonstrate the disclosed embodiments, the client device 120 is a legitimate client (operated by a real legitimate user, or other types of legitimate WEB client entities), a client device 125 is an attack tool (operated, for example, as a bot by a botnet), and the server 130 is a “victim server”, i.e., a protected server 130 under attack.

The legitimate client device 120 can be a WEB browser, or other type of legitimate WEB application client or user agent, and the like executing over a computing device, such as a server, a mobile device, an IoT device, a laptop, a PC, a connected device, smart TV system and the like.

The attack tool 125 carries out malicious attacks against the victim server 130, and particularly carries out HTTP flood attacks. The attack tool 125 is used by an attacker to generate and send “legitimate-looking” HTTP requests toward the victim server. The attacker's generated HTTP requests have the correct structure and content as required by the HTTP protocol, and by that these requests look “legitimate” even though they are malicious, as they were generated by an attacker with malicious purposes. In order to make the attack mitigation to be a very complex task, the attacker makes large use of randomization or pseudo-randomization. In some cases, the attacker generates a large set of distinct “legitimate” requests while randomly selecting the request to be transmitted. It should be noted that the attacker generates a large number of distinct HTTP requests to be able to evade fingerprinting and mitigation by simple WEB filtering or other attack mitigation means.

The attack tool 125 may be an HTTP flood attack tool that can be deployed as a botnet using WEB proxies, or as an HTTP flood attack tool without using WEB proxies. The attack tool 125 also can be deployed as a WEB stresser, DDoSers, and other “DDoS for hire” forms of attacks.

The attack tool 125 generates requests with a legitimate structure and content. To obtain the “legitimate structure,” attacker generated HTTP requests may include a legitimate URL within the protected application, a set of standard and non-standard HTTP headers, WEB Cookie, and contain one, or more, query arguments. The attack tool 125 can constantly include a specific HTTP header, or query arguments, in its generated HTTP requests or randomly decide to include them or not in each request or set of requests generated. The attack tool can also randomly select the attacked URL to be addressed in each of the requests it generates.

The attack tool 125 generated requests can also contain legitimate and varied content, or values. To make its generated requests “look” legitimate, the attack tool generated HTTP requests can have HTTP headers with legitimate values (e.g., UserAgent can be randomly selected from a predefined list of legitimate UserAgent, References can be randomly selected from a predefined list of legitimate and common WEB sites, e.g., facebook.com, google.com).

These overall operations of the attack tool 125 result of a set of tens of thousands, or even millions, of the attacker's distinct HTTP requests that can be potentially sent to the victim server 130. The attacker uses randomization to select the actual HTTP request to send toward its victim in each request transmission. Therefore, aiming to simply, or manually, recognize the millions of distinct attacker's requests “as is” by human operation teams will be a very tedious task, almost impossible. It is important to note that these tools have numerous mutations and variants but still follow similar operations, and the HTTP requests they generate are as described above. Advanced attack tools are designed to bypass simple Layer-7 filtering for mitigation by generating a large set of distinct and “legitimate-looking” HTTP requests. As such, no dominant or frequent set of several HTTP requests can be characterized as issued by the attack tool 125.

Requests generated by the legitimate client(s) are more diverse in their structure compared to the attacker's requests. The legitimate client HTTP requests potentially have more HTTP headers, standard and non-standard headers, turn to a plurality of URLs within the protected entity, which may include the victim server 130, have more key-values pairs in Cookie, use more query arguments and similar. Based on the higher diversity and content distribution of legitimate requests, the legitimate traffic applicative normal baseline is calculated, and the accurate learning of legitimate request behavior is possible.

It should be noted that the embodiments disclosed herein are applicable when multiple attack tools execute the attacks against the victim server 130 concurrently. Similarly, a vast number of legitimate client devices 120 can operate concurrently to be delivered with the services proposed by server 130. Both client devices 120 and 125 can reach the victim server 130 concurrently. The network 140 may be, but is not limited to, a local area network (LAN), a wide area network (WAN), the Internet, a public or private cloud network, a cellular network, and a metropolitan area network (MAN), wireless network, IoT network, a corporate network, a datacenter network or any combination thereof.

According to the disclosed embodiments, a defense system 110 (hereinafter “the system 110”) is deployed between client device 120, attack tool 125, and victim server 130. The system 110 is connected to a characterization device 170 (hereinafter “the device 170”) configured to carry out the disclosed embodiments. Specifically, during peacetime, the device 170 is configured to analyze requests received from the system 110 and learn the legitimate traffic applicative baselines. During an attack the device 170 uses the calculated applicative baselines to build a dynamic applicative signature, or signatures, characterizing the attack tool 125 (or the attacker) HTTP requests. The signature generated by device 170 may allow a mitigation action or policy selection. The mitigation action may be carried out by system 110. In other embodiment the mitigation actions are realized in the device 170.

An indication of an on-going attack is provided to the device 170 by the system 110. The techniques for the detection of on-going attacks are outside of the scope of the disclosed embodiments. Example techniques for detection of on-going layer-7 DDoS attacks can be found in U.S. patent application Ser. No. 18/058,482, titled TECHNIQUES FOR DETECTING ADVANCED APPLICATION LAYER FLOOD ATTACK TOOLS, assigned to the common assignee, and hereby incorporated for that it contains.

The system 110 may be deployed in an in-line or in an always-on mode, or in other types of deployments that allow peacetime baselining of incoming applicative transactions.

The system 110, device 170, and the victim server 130 may be deployed in a cloud computing platform and/or in an on-premises deployment, such that they collocate together, or in a combination. The cloud computing platform may be, but is not limited to, a public cloud, a private cloud, or a hybrid cloud. Examples for cloud computing platforms include Amazon® Web Services (AWS), Cisco® Metacloud, Microsoft® Azure®, Google® Cloud Platform, and the like. In an embodiment, when installed in the cloud, the device 170 may operate as a SaaS or as a managed security service provisioned as a cloud service. In one embodiment, when installed on-premises, the device 170 may operate as a managed security service.

In an example configuration, the system 110 includes a detector 111 and a mitigation resource 112. The detector 111 in the system 110 is configured to provide an indication of an on-going attack. The mitigation resource 112 is configured to perform one or more mitigation actions triggered by the detector 111, to mitigate a detected attack. The mitigation resource may be, but is not limited to, a scrubbing center or a DDoS mitigation device. In an embodiment, the system 110 and/or the device 170, are integrated in a DDoS mitigation device. In another embodiment, the system 110 and/or the device 170 is a multi-tiered mitigation system. The arrangement, configuration, and orchestration of a multi-tiered mitigation system are disclosed in U.S. Pat. No. 9,769,201, assigned to the common assignee, which is hereby incorporated by reference.

In an embodiment, the system 110 and/or the device 170, are integrated in a WAF (Web Application Firewall) device. In yet another embodiment, the system 110 and/or the device 170, are integrated together in any form of WEB proxy or a WEB server. In yet another embodiment, the system 110 and/or the device 170 can be integrated in WEB caching systems like CDN and others.

The victim server 130 is the entity to be protected from malicious threats. The server 130 may be a physical or virtual entity (e.g., a virtual machine, a software container, a serverless function, and the like). The victim server 130 may be a WEB server (e.g., a server under attack, an on-line WEB server under attack, a WEB application under attack, an API server, a mobile application, and so on).

According to the disclosed embodiments, throughout peacetime and during an active attack, device 170 is configured to inspect applicative transactions received from the system 110. The transactions are applicative requests, such as HTTP requests sent to the victim server 130 by both legitimate client device 120 and attack tool 125. The transactions are received at the device 170 during peacetime for the purpose of learning and baselining the normal applicative behaviors needed for the attack characterization, applicative signature generation all for the purpose of accurate and efficient attack mitigation. Upon detection of an active attack by the detector 111, the device 170 continues to receive the incoming transactions throughout the entire attack duration.

During an active attack, the device 170 is configured to analyze the received transactions and determine if an HTTP request's structure is of the attack tool (125) executing the detected attack, or a legitimate HTTP request sent by client device 120. The device 170 reports its decision on each of the received requests to the system 110. The decision can be to mitigate the request or to safely pass the requests to the victim server 130.

In yet another embodiment, and in order to improve the efficiency and cost structure of the device 170, the device 170 is fed and updated by samples of the incoming HTTP transactions. The sampling can be for 1 in N received transactions, the first received N transactions in a time window, and similar. In yet another embodiment, the sampling rate N can be different for peacetime conditions and attack time conditions, to better adjust to the number of HTTP requests transmitted toward the protected entity.

For improving efficiency and cost, other embodiments can be suggested. Here, during an active attack, the device 170 is only responsible for dynamically building the required accurate signature. Complementary, the system 110 is responsible for the actual, per transaction, mitigation activities. The device 170 is configured to pass continuously the signature to the system 110, which uses the signature for the attack mitigation. During an active attack the system 110 is configured to analyze each incoming request, compare the request to the signature provided by the device 170, and decide, on a per transaction basis, whether the transaction was generated by the client device 120, i.e., the transaction is legitimate and should be passed safely, or that the transaction was generated by the attack tool 125, i.e., the transaction is an attack and should be mitigated. In such an embodiment, device 170 can also function by analyzing all transactions without any sampling (peacetime and attack time).

Specifically, system 110 is configured to sample the incoming traffic, i.e., HTTP requests, and generate the signatures. A signature of an attack tool can be generated, modified, or updated every time window. A time window is a preconfigured time period, e.g., 10 seconds. Three (3) paraphrase buffers can be updated during each time window: window, baseline, and attack. A window paraphrase buffer is provided at each time window, a baseline paraphrase buffer is updated during peacetime (no active attack) each time window, attack paraphrase buffers are provided during the attack at each time window.

The device 170 is configured to identify the paraphrase values demonstrated in requests sent by the attack tool 125 and legitimate client, and to distinguish between them. To this end, the device 170 is configured to compare between the application's normal, peacetime, paraphrase behavior and attack time paraphrase behavior. This is realized by the comparison of peacetime paraphrase distribution from attack time paraphrase distribution. The signatures generated by the device 170 can be configured at the mitigation resource 112 to allow effective mitigation of the attack. That is, transferring safely the legitimate traffic to the protected server 130 and taking the required mitigation action on the attacker's malicious traffic based on the generated signatures.

In an example embodiment, a mitigation action may be performed, by the mitigation resource 112, selectively on the attacker traffic only. Mitigation action can be a simple blocking of the request, a response on behalf of the server 130 with a dedicated blocking page, or similar. In yet another embodiment, the mitigation action may include limiting the rate of attacker traffic or merely reporting and logging the mitigation results without any actual blocking of the incoming request. In another embodiment, the mitigation action can issue various types of challenges, e.g., captcha, to better identify the client as coming from legitimate user or attack tool operated as a bot. Further, the generated signatures can be utilized to update a mitigation policy defined in the mitigation resource 112.

In the example deployment, shown in FIG. 1, the system 110 is connected in-line with the traffic between the client device 120 and the attack tool 125 toward the victim server 130. In this deployment, the system 110 is configured to sample and process ingress traffic from the client device 120 and the attack tool 125.

In some configurations, the system 110 is also connected out-of-traffic where traffic is diverted by a switch/router, a WEB proxy (not shown), or by the protected server, to processing by the system 110. In such configurations, the device 170 is also connected out-of-path.

In yet another configuration, the system 110 may be always-on deployment. In such a deployment, the system 110 and the device 170 can be part of a cloud protection platform (not shown).

In another embodiment, the device 170 is integrated with the system 110. In such an embodiment, the processing of requests by the device 170 is performed at both peacetime and the time of the attack, regardless of the deployment of the integrated system. This integrated system can be a DDoS mitigation device, a Web Application Firewall, and the like.

It should be noted that although one client device 120, one attack tool 125, and one victim server 130 are depicted in FIG. 1 merely for the sake of simplicity, the embodiments disclosed herein can be applied to a plurality of clients and servers. The clients may be located in different geographical locations. The servers may be part of one or more data centers, server frames, a cloud computing platform, or combinations thereof. In some configurations, the victim server 130 may be deployed in a data center, a cloud computing platform, or on-premises of organization, and the like. The cloud computing platform may be a private cloud, a public cloud, a hybrid cloud, or any combination thereof. In addition, the deployment shown in FIG. 1 may include a content delivery network (CDN) connected between client device 120, attack tool 125, and server 130.

System 110 and device 170 may be realized in software, hardware, or any combination thereof. System 110 and device 170 may be a physical entity (an example block diagram is discussed below) or a virtual entity (e.g., virtual machine, software container, micro entity, function, and the like).

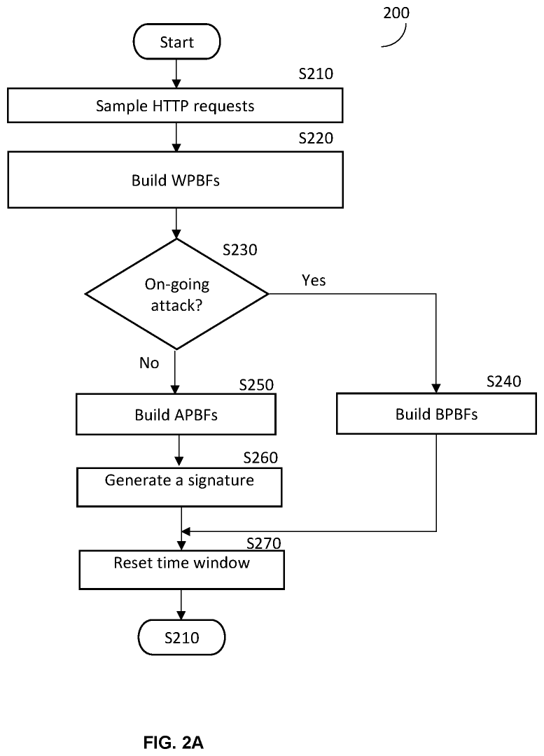

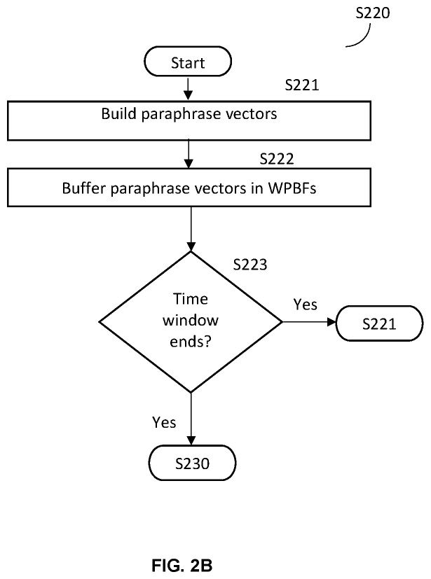

FIG. 2A shows an example flowchart 200 illustrating the characterization of HTTP flood attacks for the purpose of generating application-layer accurate attack signatures based on applicative normal baseline learned during peacetime, according to an embodiment. During an active attack, the method is designed to characterize requests generated by attackers using HTTP flood tools, such as, for example, those mentioned above, and to distinguish the legitimate requests from the attackers' requests.

The characterization is based on distinguishing the structure of legitimate HTTP requests from the structure of malicious requests based on the legitimate traffic applicative baseline structure learned during peacetime. The signature generation process discussed herein is adaptive and capable of learning a vast number of different attack tools. A new signature may be generated at the end of every time window. As such, the method presented in FIG. 2A operates at each time window. It should be emphasized that the new signatures are generated or updated only during an active attack time, correspondingly, the application's legitimate behavior normal baseline is learned only during peacetime. It should be noted that a signature is an application-layer accurate and efficient signature of an attack tool, such as those mentioned above. The generated signature can be utilized by mitigation resources to efficiently enforce a mitigation action. That is, a mitigation resource may check for a match of each incoming request to the generated signature and, based on the match, a mitigation action may be applied. For simplicity, hereinafter an application-layer signature is referred to as a “signature.”

At S210, HTTP requests directed to a protected object (e.g., server 130, FIG. 1) are sampled. The requests are sampled and processed during a time window regardless of if there is an on-going DDoS attack. Alternatively, S210 may include receiving samples of the requests. In yet another embodiment, S210 may include receiving and analyzing all the transactions without any sampling.

At S220, window paraphrase buffers (WPBFs) are built for a current time window. At peacetime and at attack time, the WPBFs represent the current window paraphrases' behavior. In an embodiment, S220 includes vectoring the HTTP requests, sampled or not, into paraphrase vectors and updating the window paraphrase buffers using their respective paraphrase values. The WPBFs provide a histogram of the structure of requests received during the current time window. The operation of S220 is discussed in more detail with reference to FIG. 2B.

Referring now to FIG. 2B, at S221, the incoming request is processed and placed in, or represented as a respective paraphrase vector. The characterization, and signature generation, is based on understanding the structure of the requests and not the contents of the request. Such structure representation is referred to here as a paraphrase. A paraphrase vector is a data structure that represents attributes of incoming HTTP requests' structure according to a notation of a respective paraphrase.

In an example embodiment, the following HTTP request attributes are included in a “paraphrase vector” of HTTP request: HTTP VERB (GET, POST, PUT, and such); a number of path elements in the request URL path; a number of query arguments in the request URL; a number of key:values cookie elements in cookie; a length of User Agent header value; the User Agent actual value; the total length in bytes of the request; a total number of “known HTTP headers” (standard HTTP headers); and a total number of “unknown headers”, i.e., all HTTP headers that are not standard HTTP headers according to any existing standards or alternatively defined. The existence, or non-existence, of a predefined set of HTTP headers are also included as paraphrases in the system paraphrase vector. This set of specific HTTP headers can be composed of standard or non-standard HTTP headers. In yet another embodiment, the paraphrase vector entities are learned dynamically, to be adaptive with the incoming traffic of a specific application.

In an embodiment, the definition of standard headers or non-standard headers can be defined dynamically. In yet another embodiment, and in order to adapt to various types of protected applications, the actual HTTP request attributes are considered a paraphrase and are included in a paraphrase vector, can be defined dynamically, learned over time, and so on. In yet another embodiment, the paraphrase vector entities are dynamically defined by the user operating the system to be adaptive to the protected application's operational or others, needs.

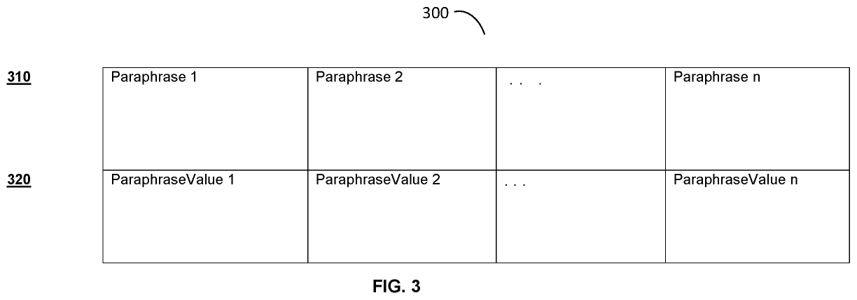

An example paraphrase vector 300 is shown in FIG. 3, where row 320 represents the paraphrase values of the respective paraphrase (attribute) in row 310. The paraphrase value can be either an integer number (e.g., number of cookie elements in the Cookie HTTP header, request size ranges), string (e.g., HTTP method type), or binary (exists or does not exist for a specific HTTP header from a predefined list).

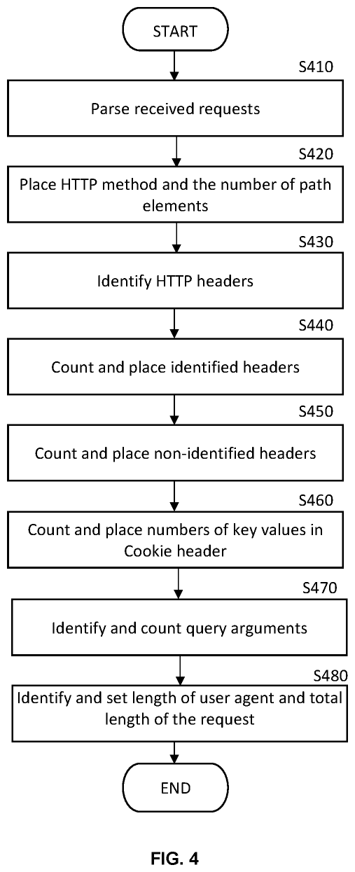

The conversion or placing of values from the received HTTP request in the paraphrase vector depends on the respective attributes. A process for generating a paraphrase vector is further discussed with reference to FIG. 4.

As the paraphrases represent the HTTP request structure, and there is a substantial difference between attacker and legitimate client request structure, it is assumed that the paraphrase vector of received HTTP requests should be used for attacker characterization in reference to the normal legitimate client applicative baseline structure behavior. Requests sent by attacker, or attackers, can be represented using a relatively small number of paraphrases, and hence paraphrase vectors. That is, the paraphrase vector represents the structure of a request. However, multiple different requests can share the same paraphrase, as the actual content of a request is not part of its paraphrase vector. It should be appreciated that using this approach, a large number (e.g., tens, thousands or millions) of attacker distinct HTTP requests are represented as a small set of paraphrases. This small set represents the HTTP requests generated by the attacker, or attackers, (e.g., attack tool 125, FIG. 1), and not by most of the legitimate clients as their paraphrase vectors are much more diverse, therefore not repetitive, and are higher in their count. The attacker traffic is represented as a set of paraphrases, and their differences from the legitimate paraphrases behavior, is the foundation of building the applicative signature.

Referring now to FIG. 2B, at S222 the paraphrase vectors, corresponding to the incoming sampled (or not sampled) HTTP requests, are buffered into an array of paraphrase buffers to provide the WPBFs. The WPBFs can be referred to as a set of paraphrase buffer representing the current window paraphrase behavior. The array is a data structure that maintains the overall occurrences of each paraphrase value, for each paraphrase, over the incoming traffic during the current time window for peacetime and also, during an active attack, for attack time windows. The array contains the same paraphrases as defined for a paraphrase vector (e.g., HTTP VERB, number of path elements in the request URL path, and exists/not exists headers), such that each paraphrase has its paraphrase buffer. A paraphrase buffer is a data structure constructed to include values of a single paraphrase. For each possible paraphrase value, the buffer has the actual “value” field along with an “occurrences” field. The occurrences represent the total aggregated number of HTTP requests with the specific value that appeared for the specific paraphrase. For each protected entity (e.g., victim server 130, FIG. 1), a single dedicated WPBFs array is maintained.

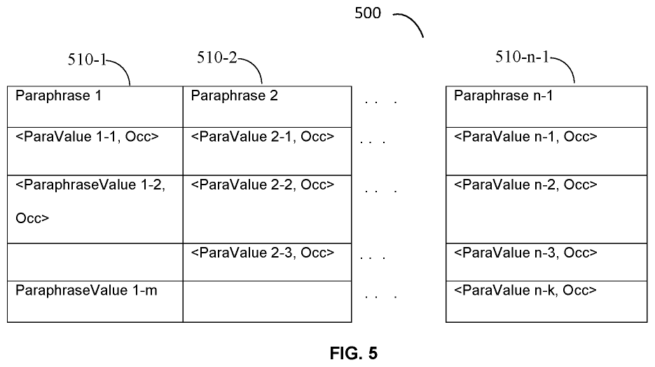

An example array 500 of paraphrase buffers is shown in FIG. 5. The array 500 includes a list of paraphrase buffers 510. Each buffer holds a list of respective paraphrase values and the number of occurrences counted for the same value. Each paraphrase can have a different number of paraphrase values. As an example, if the incoming vectors are aggregated (representing 10 different HTTP requests), and there are 5 vectors with GET method, 4 vectors POST method, and 1 vector with HEAD method, the number of occurrences for the paraphrase values GET POST, and HEAD would be 5, 4, and 1 respectively. In an example embodiment, the possible paraphrase values are predefined for each type of paraphrase. In an embodiment, the array 500 can serve for WPBFs, attack paraphrase buffers, and baseline paraphrase buffers.

Referring back to FIG. 2B, in an embodiment, S222 includes updating the respective paraphrase buffer in the array with each sampled HTTP request. In this embodiment, the vector generated or updated in response to a received HTTP request, with or without sampling, is scanned, and an occurrence count in the paraphrase buffer is incremented by one for each corresponding paraphrase value in the scanned vector. At the beginning of each time window, the occurrences count is set to zero; for a first seen paraphrase value the occurrences count is set to one.

At S223, it is checked if the time window has elapsed, and if so, execution continues with S230 (FIG. 2A); otherwise, execution returns to S221, where the building of the WPBFs continues. In some embodiments, it is checked if the number of requests being processed is over a predefined threshold. In this case, all occurrences' values in all paraphrase buffers is multiplied by, for example, a factor of 0.5 or another predefined number smaller than 1, such that warp-around is avoided.

Returning to FIG. 2A, where at S230, it is checked if an attack indication has been received during the time window or beforehand. Such an indication may be received from a detection system (e.g., system 110, FIG. 1). If an attack indication has not been received, execution continues with S240; otherwise, execution continues with S250.

At S240, baseline paraphrase buffers (BPBFs) are built based on the WPBFs. The BPBFs represent the paraphrase peacetime normal applicative behavior, or the legitimate paraphrase behavior. In an embodiment, S240 may include updating BPBFs with paraphrase value occurrences aggregated in the WPBFs from the latest time window. Then, execution continues with S270, where all occurrences' values in the WPBFs are cleared, and a new time window starts. Then execution returns to S210 for processing a new time window. It should be noted that the structure of the BPBFs is the same as the WPBFs buffers. It should be further noted BPBFs are updated at any time window if no attack indication is received.

In an embodiment, during peacetime at the end of each time window, updating the BPBFs with values aggregated in the WPBFs is realized using an Alpha filter to compute a paraphrase value mean occurrences of paraphrase values in the BPBFs for the current time window. In an embodiment, the paraphrase values mean occurrences are computed as follows:

$$Equ . 1$$

$${ParaValueOccMean}_{i , j} [ \text{} n + \text{} 1 ] = \text{} {ParaValueOccMean}_{i , j} [ n ] \cdot ( 1 - α ) + {WinParaValueOcc}_{i , j} [ n + 1 ] \cdot α$$

where, ParaValueOccMean_{i,j}[n] is the average occurrence for paraphrase value i, belongs to paraphrase j, for time window n. The WinParaValueOcc_{i,j}[n+1] is the total window occurrences for paraphrase value i, belongs to paraphrase j, as calculated in time window n+1. The α is the alpha coefficient, which defines an Alpha filter “integration” period. The “integration period” refers to the length of time that it takes to integrate. The integration period is the time on the averaging performed by the Alpha filter. In an example embodiment, the Alpha coefficient is selected as 0.001 to enable an approximation of five-hour integration period.

At S250, when there is an on-going attack, attack paraphrase buffers (APBFs) are built. The APBFs represent the paraphrase attack time behavior over the time windows, starting from the first window where the attack was detected and throughout an active on-going attack. During an on-going attack, the APBFs are updated with paraphrase value occurrences aggregated in the WPBFs from the latest time window. This is performed for each time window during the indication of an on-going attack. It should be noted that updating the APBFs does not require updating the BPBFs, thus the contents of the BPBFs remain the same during attack time.

In an embodiment, during an active attack, at the end of each time window, the APBFs are updated with values aggregated in the WPBFs using a simple summation of current window occurrences to the attack aggregated summation.

In yet another embodiment, a generated signature can be rapidly adapted to the attacker requests' structure. To this end, during an active attack, at the end of each time window, the APBFs are updated with values aggregated in the WPBFs using an Alpha Filter with a short integration period. The update is made such that the paraphrase values mean occurrences in APBFs is computed as follows:

$$Equ . 1.1$$

$${AtatckParaValueOcc}_{i , j} [ \text{} n + 1 ] = \text{} {AtatckParaValueOcc}_{i , j} [ n ] \cdot ( 1 - α ) + {WinParaValueOcc}_{i , j} [ n + 1 ] \cdot α$$

where, AttackParaValueOcc_{i,j}[n] is the average occurrences for paraphrase value i, belongs to paraphrase j, for time window n, in APBFs. The WinParaValueOcc_{i,j}[n+1] is the total window occurrences for paraphrase value i, belongs to paraphrase j, as calculated in a time window n+1. The α is the alpha coefficient, which defines the Alpha filter “integration” period. In an example embodiment, the Alpha is selected as 0.75 to enable the fast integration time, e.g., a couple of ten seconds, required for the fast adaptation to the attacker requests' structure.

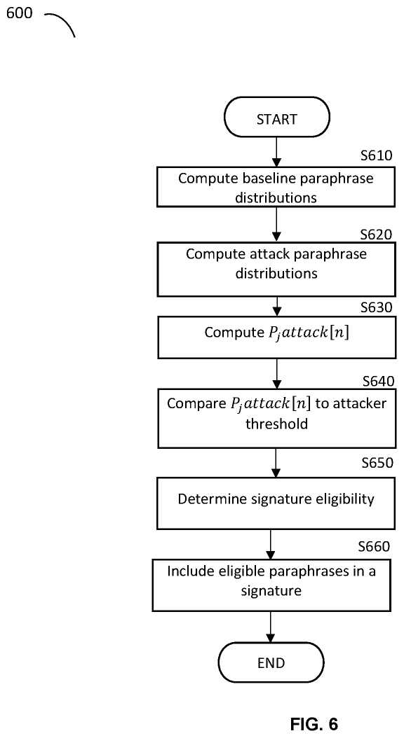

At S260, a signature of an attack tool (attacker) initiating the on-going DDoS attack is generated based on the BPBFs and APBFs. The signature includes the optimal set of paraphrase values that can efficiently block the attacker-generated HTTP requests executing the application layer DDoS attack. S260 is discussed in greater detail in FIG. 6.

In an embodiment, the generated signature is provided to a mitigation resource to perform a mitigation action on attack traffic. To this end, the mitigation resource may be configured to compare each request to the generated signature and, if there is a match, apply a mitigation action on the request. It should be noted that S250 and S260 are performed as long as the attack is a DDoS attack is on-going. An indication of an end-of-attack may be received from the detector. Such an indication would halt the generation of new signatures and any mitigation actions. After the end of the attack, a detection action is indicated, and an attack mitigation grace period may be initiated. In an embodiment, the APBFs are not updated throughout the grace period time. The signature can be kept or removed during the grace period, predefined as part of the system configuration. The grace period is a preconfigured timeline.

A mitigation action may include blocking an attack tool at the source when the tool is being repetitively characterized as matched to the dynamic applicative signature. In the case a client, identified by its IP address or X-Forwarded-For HTTP header, issues a large rate of HTTP requests that match with the dynamic applicative signature, this client can be treated as an attacker (or as an attack tool). After a client is identified as an attacker, all future HTTP requests received from the identified attacker are blocked without the need to perform any matching operation to the signature.

In some configurations, the matching of requests to signatures may include matching each paraphrase of request's paraphrase vector, to the signature. The match strictness can be configured to determine the sensitivity of the method. The sensitivity may affect the false-positive ratio of legitimate requests detected as malicious. The range of a match can be determined in percentage, where 100% would be when all the incoming paraphrase vector's values are the same as the corresponding signature. This strict match strategy can eliminate the false-positive ratio but may, in some cases, increase the false-negative ratio. To ease the matching requirements, the percentage of matching paraphrase vector's values would be, for example, between 80% and 90% (or match for all paraphrases besides 2 or 3 paraphrases). The matching percentage is a configurable parameter. The match strictness is defined in terms of the number of allowed unmatched paraphrases.

FIG. 4 is an example flowchart illustrating a process for generating a paraphrase vector according to an embodiment.

At S410, sampled HTTP requests are parsed. Specifically, the HTTP request's fields headers, and other components, are parsed and processed. At S420, the information in the HTTP method's field is copied from the request into its corresponding “HTTP Method” paraphrase value cell in the vector. The value can be “GET,” “POST,” or “HEAD,” or any other HTTP method.

At S420, the number of path elements is counted from the URL path designated in the request. Every “\” is counted. For example, for the path “\pictures\images\2021\July\” the value is 4. For the root “\” its paraphrase is 0.

At S430, known HTTP headers are identified in the parsed request. This can be performed by first finding (e.g., using regular expression) all strings designated as known headers. For example, the Accept* paraphrase is built by finding the existences of all HTTP headers starting with ‘Accept-*’ (e.g., Accept, Accept-Encoding, Accept-Language, and so on). If at least one Accept* header is found in a request, then the paraphrase value is EXIST. Otherwise, the paraphrase value will be NOT-EXIST. In an embodiment, the known headers include, yet are not limited to, the following headers: Referrer, User-Agent, Host, Authorization, Connection, Cache-Control, Date, Pragma, Expect, Forwarded, From, Max-Forwards, Origin, Prefer, Proxy-Authorization, Range, Transfer-Encoding, Upgrade, Via, Accept* (all HTTP headers that starts with Accept), Content* (all HTTP headers that starts with Content), Sec-(all HTTP headers that starts with Sec-), and If-* (all HTTP headers that starts with If-), and similar HTTP headers, standard and not standard. In an embodiment, the known headers are defined using a static list of standard HTTP headers. In yet another embodiment, the known headers can be defined dynamically and learned upon their appearance in the incoming HTTP transactions.

At S440, all identified known headers are counted, and the respective value is set as a paraphrase value for the total number of “known HTTP headers.” Each appearance of a known header is counted as 1, and the total count of all headers “known HTTP headers” is set accordingly.

At S450, any header that is not identified (e.g., by the above-mentioned regular expression) is counted and added to the respective paraphrase, the total number of unknown headers. If no unknown headers are found, the respective paraphrase value is set to zero.

At S460, any cookie header in the received HTTP request is identified, and a number of key: value in the cookie are counted and added to the respective paraphrase, the total number of key:value in cookie. If no cookie header is found, the respective paraphrase value is set to zero.

At S470, any query arguments in the URL of the received HTTP request is identified and parsed, and the total number of query arguments URL are counted and set at the respective paraphrase, the number of query arguments in the request URL. If no query argument is found, the respective paraphrase value is set to zero.

At S480, the User Agent and the total length of the received HTTP request are identified and parsed. Further, the length of User Agent header is counted and set to the respective paraphrase, the length of User Agent header. If no User Agent HTTP header is found, the respective paraphrase value is set to zero. Same applies to the User Agent actual value. Furthermore, the total length in bytes of the received HTTP request is counted and set to the respective paraphrase, the total length HTTP requests. In an embodiment, the total length of the HTTP request is defined by ranges, e.g., 0-99, 100-199, until 390-3999 bytes. In yet another embodiment, the count of origin of the source IP generated by the request (GEO IP) is identified and set, and the source IP can be defined by the Layer 3 IP headers or by the X-Forwarded FOR HTTP header.

The processes described herein are performed for sampled HTTP requests sent by both client device 120 and/or the attack tool 125 toward the victim server 130 (as in FIG. 1). The requests can be converted into one or more paraphrases, each of which with a respective paraphrase vector.

FIG. 6 shows an example flowchart 600 illustrating the process of generating the signature of an attack tool (attacker) during an active attack and according to an embodiment. This process is realized at the end of each time window during an active attack.

At S610, baseline paraphrase distributions are computed using the BPBFs. This may include transforming the baseline paraphrase histogram (represented by the BPBFs) to a probability distribution function. In an embodiment, the baseline paraphrase distributions are computed as follows:

$${BaselineParaValueProb}_{i , j} [ n ] = \frac{{ParaValueOccMean}_{i , j} [ n ]}{{\sum }_{k} {ParaValueOccMean}_{k , j} [ n ]} \qquad Equ . 2$$

where, the BaselineParaValueProb_{i,j}[n] is the probability of appearance of Paraphrase Value i, belongs to Paraphrase j, for time window n. The ParaValueOccMean_{i,j}[n] is the average (baseline) occurrences for Paraphrase Value i, belongs to Paraphrase j, for time window n, as recorded in the baseline paraphrase buffers. Elaborated also in FIG. 1.

At S620, attack paraphrase distributions are computed using the APBFs. This may include a transformation attack paraphrase histogram (represented by the APBFs) to a probability distribution function. In an embodiment, the attack paraphrase distributions are computed as follows:

$${AttackParaValueProb}_{i , j} [ n ] = \frac{{ParaValueOccMean}_{i , j} [ n ]}{{\sum }_{k} {ParaValueOccMean}_{k , j} [ n ]} \qquad Equ . 3$$

where, AttackParaValueProb_{i,j}[n] is the probability of appearance of Paraphrase Value i, belongs to Paraphrase j, for time window n of an active attack. The ParaValueOccMean_{i,j}[n] is the aggregated occurrences for Paraphrase Value i, belongs to Paraphrase j, for time window n, as recorded in the attack paraphrase buffers.

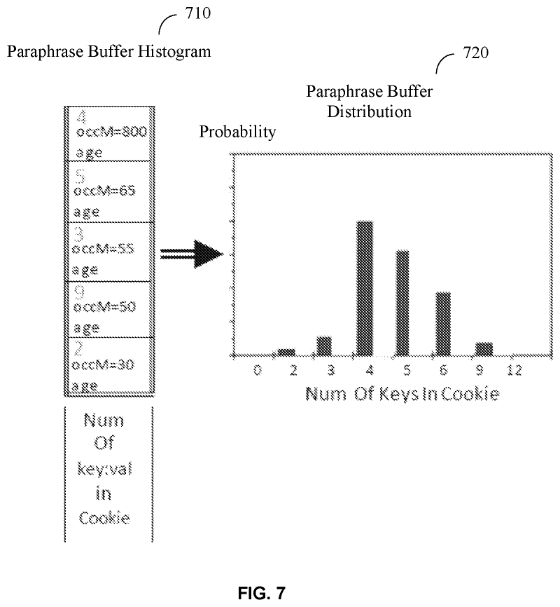

An example demonstrating the transformation from a histogram to paraphrase distributions (either for attack or baseline) is shown in FIG. 7. In this example, the paraphrase is the “Num of key:val in Cookie”. The respective paraphrase is labeled 710 and the distribution graph is labeled 720.

At S630, a probability Pⱼattack[n] of an attacker to generate an attack using a specific paraphrase (j), each specific value is computed. In an embodiment, the Pⱼattack [n] is computed as follows:

$${P}_{j} attacker [ n ] = {P}_{j} attack [ n ] \cdot \frac{1 + AF [ n ]}{AF [ n ]} - {P}_{j} baseline \cdot \frac{1}{AF [ n ]} \qquad Equ . 4$$

where, Pⱼattack[n] and Pⱼbaseline are derived from the computed attack paraphrase distributions and baseline paraphrase distributions, respectively. The function AF[n] is the attack factor, i.e., the RPS generated by the attacker divided by the RPS generated by the legitimate clients:

$$AF [ n ] = \frac{Attacker RPS [ n ]}{Legit R PS [ n ]} \qquad Equ . 5$$

and may be completed as follows:

$$AF [ n ] = {\sum }_{l = 1}^{n - a . d . t} \frac{( AttackRSP [ l ] - BaselineRPS )}{BaselineRPS} \qquad Equ . 5.1$$

where, a.d.t is the actual attack detection time, and ‘n’ is the current time window. AttackRPS[n] is the true average RPS as measured during the time window n when the attack is active. The BaselineRSP represents the average legitimate RPS as a measure before the attack has started. In an embodiment, the BaselineRSP is computed as an average over one hour period before the attack has started. In yet another embodiment, the BaselineRSP is computed as the summation of an average over one hour period before the attack has started and a predefined number of corresponding standard deviations.

In cases the APBFs average paraphrase values are computed using Equ. 1.1, the AF[n] is calculated as an average using an Alpha filter over AF[n] values using:

$$AF [ n + 1 ] = AF [ n ] \cdot ( 1 - α ) + \frac{AttackRPS [ n + 1 ] - BaselineRPS}{BaselineRPS} α \qquad Equ . 5.2$$

In an example embodiment, with correspondence to Equ. 1.1, the Alpha is selected as 0.75 to enable the fast integration time, e.g., a couple of ten seconds, required for the fast adaptation to the attacker requests' structure.

It should be noted that the S630 is performed for each paraphrase.

At S640, the attacker probabilities Pⱼattacker[n], for each paraphrase j and each of its values are compared to a predefined attacker threshold. All the respective paraphrase values of attacker probabilities Pⱼattacker[n] exceeding the threshold are added to an attacker buffer, and the rest paraphrase values are added to a legitimate buffer. The paraphrase values in the attack buffer are candidates to be included in the adaptive signature. That is, such paraphrase values are likely to be executed by an attacker and generated on-going by the attack tool the attacker is using. In an embodiment, the attacker threshold is preconfigured and defines the mitigation or sensitivity.

At S650, the signature eligibility of each paraphrase is determined. That is, the signature eligibility determines if the respective paraphrase values of each paraphrase in the attacker buffer should be included, or not included in the signature. The eligibility is determined by summing the baseline (peacetime) distributions of all paraphrase values in the legitimate buffer and comparing the summation to a predefined legitimate threshold. If the distribution sum exceeds the legitimate threshold, the paraphrase values in the attacker buffer are considered signature eligible because the required level of legitimate traffic, with certain values in the legitimate buffer, is expected to be excluded from the signature. If the distributions sum exceeds the legitimate threshold, the paraphrase values in the APBFs are eliminated from the signature, and the paraphrase is not part of the signature. This activity ensures the efficiency of the generated signature. In an embodiment, the legitimate threshold is preconfigured and defines mitigation or sensitivity.

At S660, all paraphrase values that are signature eligible are added to a data structure representing the signature of the attacker executing the on-going attack. The signature characterizes the attacker and further used in the next time window for the actual attack mitigation.

Following are two examples, showing eligible and non-eligible paraphrases. In the first example, the paraphrase is Num of Keys in Cookie. The paraphrase values are ‘0’, ‘1’, ‘2’, ‘3’, ‘4’, ‘5’, and ‘6’. The computed Pⱼattacker is as follows:
Pⱼattacker(paraValue=0)=0.495; Pⱼattacker(paraValue=1)=0.098;
Pⱼattacker(paraValue=2)=0.098, Pⱼattacker(paraValue=3)=0.101;
Pⱼattacker(paraValue=4)=0.104; Pⱼattacker(paraValue=5)=0.102; and
Pⱼattacker(paraValue=6)=0

The attacker threshold is set at 0.1, thus, all values but “paraValue=6” will be included in the attacker buffer. The legitimate threshold is 0.01, The total legit probability is 23%, thus the paraphrase (Num of Keys in Cookie) is eligible and will be included in the attacker's signature. This enables signature accuracy and efficacy.

In the second example, the paraphrase is the HTTP method. The paraphrase values are ‘GET’, ‘POST’, ‘DELETE’, ‘HEAD’, and ‘PUT’. The computed Pⱼattacker values are: Pⱼattacker(paraValue=GET)=0.498; Pⱼattacker(paraValue=POST)=0.501; Pⱼattacker(paraValue=DELETE)=0; Pⱼattacker(paraValue=HEAD)=0; and Pⱼattacker(paraValue=PUT)=0.

The attacker threshold is set 0.2, thus all 2 values ‘GET’ and ‘POST’ will be included in the attacker buffer. The total legit probability is about 0%, thus, the paraphrase (HTTP method) is ineligible and will not be included in the attacker's signature.

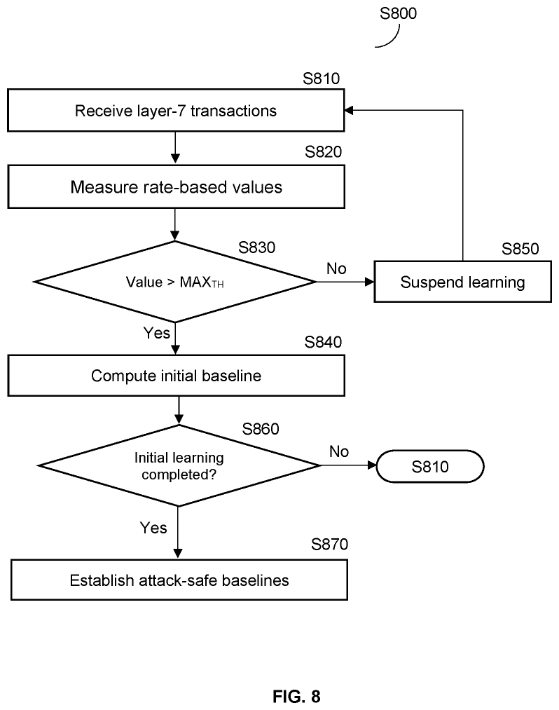

FIG. 8 shows a flowchart of an example process (800) used for an initial learning process to establish an initial baseline in accordance with an embodiment. This baseline is established for a rate-based application attribute. The process shown in FIG. 8 can be carried out by the system (FIG. 1, 110) throughout the initial learning period and prior to the detection and mitigation of DDoS attacks.

At S810, application-layer transactions directed to a protected entity are received. For example, system 110 may receive application-layer transactions directed to a protected entity, as described above. The received transactions are web transactions and typically include HTTP requests and their corresponding responses to/from a protected entity hosted by a victim server. In an embodiment, S810 may include receiving data during predefined time windows. The process is performed for each time window.

At S820, values of at least one rate-based attribute are measured from the received application-layer transactions. For example, a rate-based attribute may include the incoming transactions requests per second (RPS) rate. In yet another embodiment, the rate invariant attributes can also be measured during this stage.

At S830, it is determined, based on the measured rate-based attribute, that the received application-layer transactions represent an initial normal behavior. Specifically, S830 includes comparing the measured rate-based attribute to a predefined threshold related to a maximum rate-based attribute value RPS (MaxTH). For example, if the measured rate-based attribute is RPS, the threshold is a maximum RPS (RPS_{MAX}) which RPS below this rate are considered as normal. In an embodiment, such a threshold is pre-configured. In another embodiment, the maximum threshold may be learned based on, for example, similar protected entities.

If S830 results in a Yes answer (i.e., the value is below the maximum threshold), execution continues with S840. Otherwise, if an abnormal rate-based attribute is detected, as S850, the learning is suspended.

When an abnormal rate-based attribute is detected, the learning process comes to a halt. The suspension period lasts as long as the measured rate-based attribute is higher than the maximum threshold (MaxTH). The execution returns to S810 where transactions received during a subsequent time window are processed, in part, to check if the rate-based value returns to a value below the maximum threshold, and if so, and the suspension is ended. In an embodiment, the suspension period can be timed out (for example, after one hour). Once the suspension period is over, the learning process restarts again, and the execution returns to S840.

At S840, an initial baseline is computed over the application-layer transactions determined to obtain an initial assessment of the actual rate base normal behavior. The initial baseline is computed for rate-based attributes, mostly for the purpose of safeguarding the initial learning process. In yet another embodiment, rate invariant attributes (e.g., application attribute) initial baseline can also be calculated. In addition, and for the purpose of accurate attack mitigation, the initial computed baseline(s) are built and calculated for the various paraphrases. The initial baseline is saved in an initial baseline paraphrase buffer (BPBFs). Such BPBFs represent a paraphrase normal behavior.

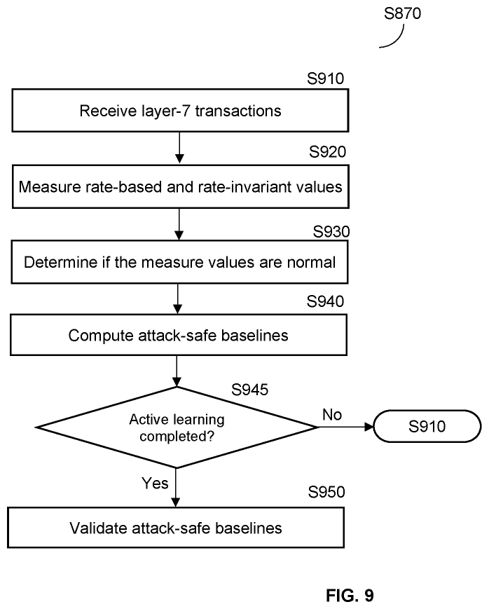

At S860, it is determined if the initial learning phase has elapsed. If so, execution continues with S870, where attack-safe baselines are actually established as discussed in FIG. 9. Otherwise, execution returns to S810 where transactions received during a subsequent time window are processed.

In an embodiment, S810 may include receiving data during predefined time windows. The process is performed for each time window. The time window is set to a predefined number of seconds.

In an embodiment, the duration of an initial learning period is pre-determined, e.g., 1 hour. In another embodiment, the initial learning period is based on a predefined number of processed transactions (for example, 5,000 transactions). It should be noted that the initial learning period may be a combination of the number of transactions and time duration.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a flowchart of an example process S870 for safeguarding a learning process to establish attack-safe baselines during the active learning period according to an embodiment. The baselines may be for a rate-based and/or rate-invariant application attributes for the process of assuring the attack-safe learning of the various paraphrase buffers baselines needed for the accurate attack mitigation. The disclosed process of FIG. 9 may be performed by system 110 (FIG. 1) prior to the detection and mitigation of DDoS attacks and prior to accurate attack characterization which is based on baselines.

At S910, application-layer transactions directed to a protected entity are received and analyzed. For example, system 110 may receive application-layer transactions directed to a protected entity, as described above. In an embodiment, the received transactions are web transactions and typically include HTTP requests to and their corresponding responses to/from a protected entity hosted by a victim server. In an embodiment, S910 may include receiving data during predefined time windows. The process is performed for each time window. The time window is set to a predefined number of seconds.

At S920, values of at least one rate-based attribute and at least one rate-invariant attribute are measured from the received application-layer transactions. For example, a rate-based attribute may include requests per second. Other examples of rate-based and rate-invariant attributes from the received application-layer transactions are described above. In an embodiment, rate-invariant attributes are the various application attributes.

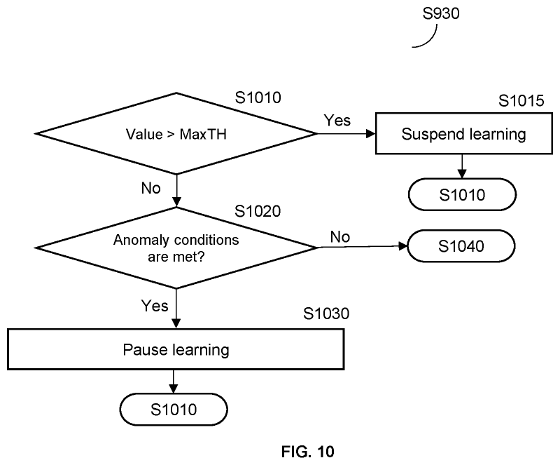

At S930, it is determined, based on the measured rate-based attribute, that the received application-layer transactions represent normal behavior. In an embodiment, the determination is based on at least one measured rate-based attribute. Specifically, as will be discussed in detail below, the determination includes comparing the measured rate-based attribute to predefined thresholds related to the maximum and minimum values of the rate-based attribute. This further includes comparing the value of the rate-based attribute to an anomaly factor to determine any abnormal changes in the value. The learning process is paused when the measured rate-based attribute is determined to be abnormal. The time when the measured rate-based attribute is determined to be normal is referred to as an active learning time. In another embodiment, the determination is based on at least one measured rate-invariant attribute. The operation of S930 is discussed in more detail with reference to FIG. 10.

At S940, baselines are computed over the application-layer transactions determined to represent the normal behavior. A baseline is computed for rate-based attributes and may include short and medium baselines. S940 further includes computing baselines for rate-invariant attributes. In an embodiment, both rate-based and rate-invariant baselines are computed to ensure accurate characterization of detected attacks. The attack accurate characterization attributes are introduced as a paraphrase. A paraphrase includes at least one paraphrase value, where a paraphrase value represents an applicative attribute in a transaction. As noted above, the paraphrase value is any one of: an HTTP VERB; a number of path elements in a request URL path; a number of query arguments in the request URL; a User Agent actual value, a number of key:values cookie elements in cookie; a length of User Agent header; a total length in bytes of the request; a total number of known HTTP headers; a total number of unknown headers; and existence, or non-existence, of a predefined set of HTTP headers, existence of a dynamically defined set of HTTP headers, geographical information on an origin of the attacker.

In an embodiment, S940 may further includes computing paraphrase values mean occurrences defined at the BPBFs for a current time window based on an average of occurrences for paraphrase values in the BPBFs computed for a previous time window, a total of occurrences for paraphrase values in the WPBFs for a current time window, based on an Alpha filter. The detailed calculation approaches are described above.

The process checks at S945 if the active learning period has ended. When the learning period has ended, the process moves to S950. If not, the process returns to S910 where new transactions received during the next time window are processed. The check performed at S945 also verifies if the active learning period was continuous. This means that the paused times during learning are not included in the active learning period. The duration of the learning period can be pre-configured to, for example, 24 hours or a specific number of processed transactions (such as 100,000). The learning period can be a combination of both time duration and number of transactions.

At S950, after the active learning period has concluded, the computed baseline is validated. In an embodiment, the validation is performed on the measured rate-invariant and rate-based attributes.

In an embodiment, S950 includes checking if two conditions are satisfied, one rate-based condition and another rate-invariant condition. The rate-based condition ensures that an adequate number of transactions are processed for the purpose of learning and may include, for example:
RateCondition>SuccessValidationRate

The RateCondition is defined as a ratio between the measured number of windows with adequate number of transactions and a validation period duration.

For example, the required measured number of windows with an adequate number of transactions may include the number of windows slots with at least 500 transactions, and the validation period may be 24 hours. In an embodiment, the SuccessValidationRate is a pre-configured static threshold (e.g., 0.75). In an example, RateCondition may be 18 windows with the pre-defined number of transactions received for 24 hours, thus the rate condition is 18/24=0.75. The active learning period may be the same as the validation period.

In an embodiment, the rate-invariant condition ensures a stable measurement of the application behavior attribute that is substantially below the application behavior threshold, throughout the active learning period. The rate-invariant condition is measured by the AverageAppBehaviorMargin attribute and is calculated as:
AverageAppBehaviorMargin>SuccessValidationAppMargin
   The various embodiments for computing the application behavior are discussed in the above-referenced application Ser. No. 18/058,482.

The SuccessValidationAppMargin is a static threshold (e.g., 0.5). The AverageAppBehaviorMargin is a measured metric that represents the distance between the rate-invariant attribute and its threshold. The SuccessValidationAppMargin is calculated as follows:

$$AverageAppBehaviorMargin = \frac{1}{N} \cdot {\sum }_{i = 0}^{N - 1} \frac{AppBehaviorTH [ n - i ] - AppBehavior [ n - i ]}{AppBehaviorTH [ n - i ]}$$

where, N represents the number of time windows of active learning.

It should be noted that for successful learning to be achieved, both rate-based and rate-invariant conditions should be met. If the successful learning conditions are not met, the entire learning is re-initiated for several attempts (e.g., 3 attempts). After a successful learning period, the behavioral accurate characterization of attackers' transactions can be safely initiated. In an embodiment, if the learning was not successful, the attack mitigation may be based on paraphrases that were not computed using baselines. Examples for such mitigation can be found in U.S. Pat. Nos. 11,552,989 and 11,582,259, assigned to the common assignee and hereby incorporated by reference.

In another embodiment, when the initial learning is concluded and non-baseline mitigation is operable, the baseline validation continues as a background process. The validation conditions are checked at predefined time intervals, each 24 hours. If, during the continuous validation, the two conditions are met, the accurate mitigation is turned to be based on full behavioral attributes, and baseline-based attack mitigation is done, as mentioned-above.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a flowchart of an example process S930 for determining if application-layer transactions represent a normal behavior according to the disclosed embodiments.

At S1010, the value of the measured rate-based attribute is compared to a threshold (MaxTH) representing a maximum learnable value for the rate-based attribute, meaning that the values above are considered high-rate anomalies, and thus should not be learned during the learning period. In an embodiment, high-rate anomalies can be a potential for HTTP flood attacks that should not be learned. If S1010 results in a Yes answer, the learning is suspended (S1015). Otherwise, execution continues with S1020. As noted above, after the suspension time, the learning process is restarted. Alternatively, the learning is resumed when the rate-based attribute returns to values below the MaxTH.

Thus, according to this embodiment, the value of the measured rate based below the high threshold potentially represents normal behavior and introduces active learning. It should be noted that the MaxTH threshold is also used applicable during the initial learning

At S1020, it is determined if a value of the measured rate-based attribute has changed by an anomaly factor, during a time window. In an embodiment, a measured rate-based attribute that has not changed by the anomaly factor represents a normal behavior that can be considered as attack safe conditions and therefore the baselines can be learned. In an embodiment, S1020 includes checking if one of two conditions is met: “learning anomaly high” and “learning anomaly low” are met. These conditions may be defined as follows.

### 1. Learning Anomaly High

RateAttribute>rateShortAverage*LearnAnomalyFactor
and
RateAttribute>MinTH

### 2. Learning Anomaly Low

RateAttribute<rateShortAverage/LearnAnomalyFactor
and
rateShortAverage>MinRps

The rateShortAverage is a calculated average over a short period of time (e.g., 1 hour). In one embodiment, the LearnAnomalyFactor is a static configurable number (e.g., set to 5 by default). In another embodiment, the LearnAnomalyFactor is a behavioral calculated factor. The RateAttribute is a value of the measured rate-based attribute. In an embodiment the RateAttribute is the average RPS measured on a time window. The MinTH is a threshold representing a minimum value for the rate-based attribute. Such a threshold may be predetermined and, for example, represents RPS values that should never be considered as an attack. Note that when the rate-based value (e.g., RPS) is lower than the MinTH, the incoming traffic is learned. The various embodiments for computing the rateShortAverage are discussed in the above-referenced application Ser. No. 18/058,482. It should be noted that the ShortAverage can be computed for rate-based, rate-invariant, application behavior, attributes, and the like.

If S1020 results with a Yes (e.g., one of the Learning Anomaly High and Learning Anomaly Low conditions is met), execution proceeds for S1030; otherwise, execution continues with S940 (FIG. 9) where the baselines are established based on normal application values.

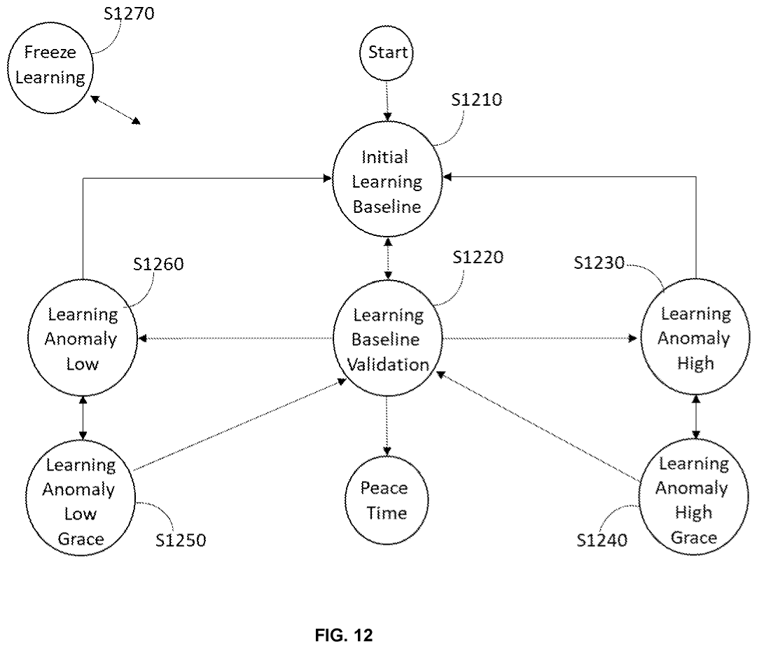

At S1030, the learning is paused. It should be noted that the learning is paused as long as the measured rate-based attribute anomaly behavior remains persistent. While pausing the learning values of new transactions are checked against the above-mentioned anomaly conditions (for example, such as in S1010, S1040). According to an embodiment, a state machine is implemented to resume learning. The state machine comes to ensure that traffic has returned to normal values before the resumption of learning the baseline. An example state machine is provided in FIG. 12.

The process described with reference to FIG. 10 is performed as long as new transactions are received during the active learning period.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

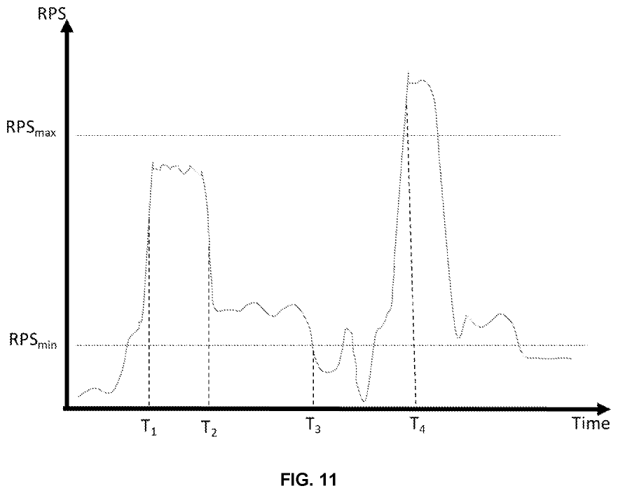

FIG. 11 shows an example graph 1100 demonstrating the process described in FIGS. 8, 9 and 10. The rate-based attributes measured in FIG. 11 are from incoming requests per second (RPS). The maximum and minimum thresholds are marked as MaxRPS and MinRPS. At time T1, the learning is paused due to a steep increase in RPS; at time T2, Learning is paused due to a steep decrease in RPS; at time T3, the base learning is paused as the RPS is lower than RPSmin; and at time T4 the baseline learning is paused as the RPS is higher than RPSmax.

FIG. 12 shows an example diagram of a state machine illustrating the process performed during the baseline learning period according to an embodiment.

The learning process is divided into two states. The first state, documented as S1210, is the initial learning process which is illustrated in FIG. 8. When the initial learning process is completed successfully, the next state S1220 focuses on the active learning and validating the baselines for rate-based, rate-invariant, and various paraphrases features. The objective of S1220 is to ensure the required duration of actual active learning without any potential anomalies, in an embodiment, the active learning duration can be at least 24 hours. At the end of this time, the detection system checks the “quality of learning” by verifying that the “successful learning conditions” have been met. If the successful learning conditions are not met, the entire learning process is re-initiated a pre-configured number of times (e.g., 3 times). Once the successful learning conditions are met, peacetime anomaly detection and attack characterization and mitigation can be started based on baselines. If the learning process is successful, accurate attack detection and characterization can begin.

Execution continues with S1270, S1230, or S1240 depending on which of the anomaly conditions has been met. For example:
1. when the condition RPS>MaxTH is met; move to state S1270;
2. when the learning high anomaly condition is met; move to S1230; and
3. when the learning low anomaly condition is met; move to state S1260.

S1230 is the state of high learning anomaly. In this state, the system checks if the high-rate condition has ceased. If so, it moves to S1240, which corresponds to the learning anomaly high grace state. However, if the high-rate condition persists for a period of more than, e.g., 5 hours, the system returns to S1210 to re-initiate the baseline learning.

S1240 is the learning anomaly high grace state. Here, it is checked if the learning high anomaly condition has not been resumed, for example, for the last 2 minutes. If so, the system returns to S1220; otherwise, the system returns to S1230.

It should be noted that the state machine operates similarly at S1250 and S1260. The check at both states is against the low anomaly condition.

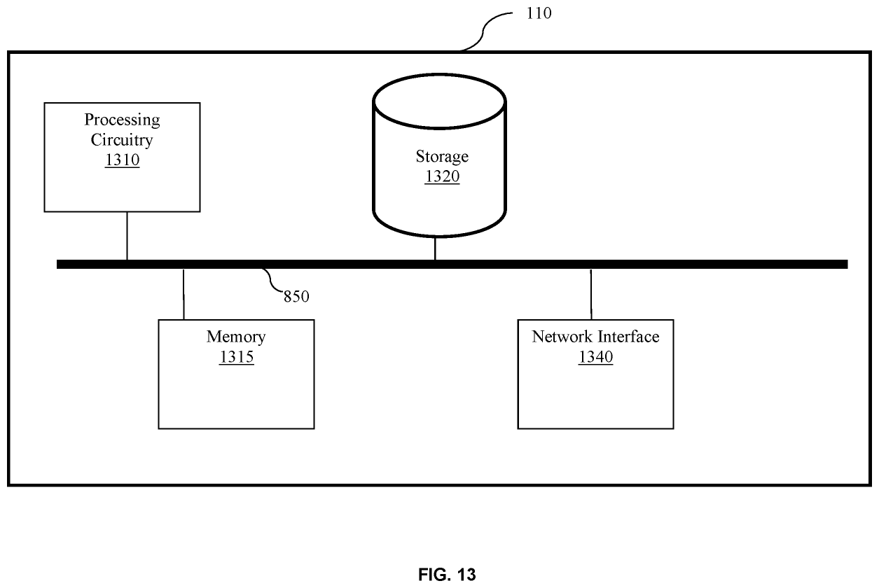

FIG. 13 is an example block diagram of system 110 implemented according to an embodiment. The system 110 includes a processing circuitry 1310 coupled to a memory 1315, storage 1320, and a network interface 1340. In another embodiment, the components of the system 110 may be communicatively connected via a bus 1350.

The processing circuitry 1310 may be realized as one or more hardware logic components and circuits. For example, and without limitation, illustrative types of hardware logic components that can be used include field-programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 1315 may be volatile (e.g., RAM, etc.), non-volatile (e.g., ROM, flash memory, etc.), or a combination thereof. In one configuration, computer-readable instructions to implement one or more embodiments disclosed herein may be stored in storage 1320.

In another embodiment, the memory 1315 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by one or more processors, cause the processing circuitry 1310 to perform the various processes described herein. Specifically, the instructions, when executed, cause the processing circuitry 1310 to perform the embodiments described herein.

The storage 1320 may be magnetic storage, optical storage, and the like, and may be realized, for example, as flash memory or other memory technology, CD-ROM, Digital Versatile Disks (DVDs), or any other medium which can be used to store the desired information.

The network interface 1340 allows the device to communicate at least with the servers and clients. It should be understood that the embodiments described herein are not limited to the specific architecture illustrated in FIG. 13, and other architectures may be equally used without departing from the scope of the disclosed embodiments. Further, the system 110 can be structured using the arrangement shown in FIG. 14.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to promoting the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

What is claimed is:

1. A method for learning attack-safe baselines, comprising:
receiving application-layer transactions directed to a protected entity;
measuring values of a rate-based attribute and a rate-invariant attribute from the received application-layer transactions;
determining, based on the measured rate-based attribute, if the received application-layer transactions represent a normal behavior;
computing at least one baseline using application-layer transactions determined to represent the normal behavior;
validating the at least one computed baseline using the measured rate-invariant attribute and rate-based attribute; and
building a set of baselines based on the at least one validated baseline, wherein the set of baselines are utilized for characterization of DDoS attacks.

2. The method of claim 1, wherein computing the at least one baseline is performed during time windows.

3. The method of claim 2, further comprises:
computing paraphrase values mean occurrences for the BPBFs for a current time window based on an average of occurrences for paraphrase values in the BPBFs computed for a previous time window, a total of occurrences for paraphrase values in the WPBFs for a current time window, and using an Alpha filter.

4. The method of claim 1, further comprising: generating, using at least one computed baseline, an application-layer signature designating applicative attributes utilized for characterization of DDoS attacks.

5. The method of claim 1, wherein determining if the received application-layer transactions represent a normal behavior, further comprises:
providing an initial assessment of the measured rate-based attribute.

6. The method of claim 5, wherein determining if the received application-layer transactions represent a normal behavior, further comprises:
comparing the measured rate-based attribute to a first threshold and a second threshold, wherein the first threshold represents a maximum value for the rate-based attribute and the second threshold represents a minimum value for the rate-based attribute, wherein a measured rate-based attribute above the first threshold represents an abnormal behavior.

7. The method of claim 6, further comprising:
determining if the measured rate-based attribute has changed by an anomaly factor, wherein a measured rate-based attribute that has not changed by the anomaly factor represents a normal behavior.

8. The method of claim 7, wherein determining if the measured rate-based attribute has changed by an anomaly factor, further comprises:
checking if a current measured value of the rate-based attribute changes from its average measured value by the anomaly factor.

9. The method of claim 7, further comprising:
pausing baseline learning when a received measured rate-based represents an abnormal behavior.

10. The method of claim 7, further comprising:
re-initiating the learning process when a received measured rate-based represents a normal behavior.

11. The method of claim 1, wherein validating the computed rate-based baseline further comprises:
determining if a preconfigured active learning period has been completed, wherein the preconfigured active learning period includes durations or a number of transactions received during which application-layer transactions determined to represent the normal behavior utilized to compute the at least one baseline; and
determining if a quality learning condition has been met.

12. The method of claim 11, wherein the determining if a quality learning condition includes checking if a measured rate-invariant attribute is higher than a rate-invariant quality threshold and a measured rate-based attribute is higher than a rate-based quality threshold.

13. The method of claim 12, further comprising:
determining that the baseline cannot be established for the protected entity when the at least one computed baseline learned has not met at least one quality learning condition.

14. The method of claim 1, wherein building the set of baselines further comprises:
building a set of baseline paraphrase buffers (BPBFs) from at least one validated baseline, wherein each BPBF represents a normal behavior of a paraphrase.

15. The method of claim 1, wherein the paraphrase includes at least one paraphrase value, wherein a paraphrase value represents an applicative attribute in an application-layer transaction.

16. The method of claim 1, wherein application-layer transactions include any one of: HTTP requests, HTTP responses, HTTPs requests, and HTTPs responses.

17. The method of claim 16, wherein application-layer transactions include samples of the actual HTTP requests, their corresponding HTTP responses, wherein a sampling rate of the actual HTTP requests differs as a function of the protected entity incoming traffic volumes.

18. The method of claim 1, wherein the attack-safe baselines are utilized for the characterization and mitigation of application layer flood denial-of-service (DDoS) attacks carried by attackers utilizing advanced application layer flood attack tools.

19. A system for learning attack-safe baselines comprising:
one or more processors configured to:
receive application-layer transactions directed to a protected entity;
measure values of a rate-based attribute and a rate-invariant attribute from the received application-layer transactions;
determine, based on the measured rate-based attribute, if the received application-layer transactions represent a normal behavior;
compute at least one baseline using application-layer transactions determined to represent the normal behavior;
validate the at least one computed baseline using the measured rate-invariant attribute and rate-based attribute; and
build a set of baselines based on the at least one validated baseline, wherein the set of baselines are utilized for characterization of DDoS attacks.

20. The system of claim 19, wherein computing the at least one baseline is performed during time windows.

21. The system of claim 20, further comprises:
computing paraphrase values mean occurrences for the BPBFs for a current time window based on an average of occurrences for paraphrase values in the BPBFs computed for a previous time window, a total of occurrences for paraphrase values in the WPBFs for a current time window, and using an Alpha filter.

22. The system of claim 19, further comprising:
generating, using at least one computed baseline, an application-layer signature designating applicative attributes utilized for characterization of DDoS attacks.

23. The system of claim 19, wherein determining if the received application-layer transactions represent a normal behavior, further comprises:
providing an initial assessment of the measured rate-based attribute.

24. The system of claim 23, wherein determining if the received application-layer transactions represent a normal behavior, further comprises:
comparing the measured rate-based attribute to a first threshold and a second threshold, wherein the first threshold represents a maximum value for the rate-based attribute and the second threshold represents a minimum value for the rate-based attribute, wherein a measured rate-based attribute above the first threshold represents an abnormal behavior.

25. The system of claim 24, further comprising:
determining if the measured rate-based attribute has changed by an anomaly factor, wherein a measured rate-based attribute that has not changed by the anomaly factor represents a normal behavior.

26. The system of claim 25, wherein determining if the measured rate-based attribute has changed by an anomaly factor, further comprises:
checking if a current measured value of the rate-based attribute changes from its average measured value by the anomaly factor.

27. The system of claim 25, further comprising:
pausing baseline learning when a received measured rate-based represents an abnormal behavior.

28. The system of claim 25, further comprising:
re-initiating the learning process when a received measured rate-based represents a normal behavior.

29. The system of claim 19, wherein validating the computed rate-based baseline further comprises:
determining if a preconfigured active learning period has been completed, wherein the preconfigured active learning period includes durations or a number of transactions received during which application-layer transactions determined to represent the normal behavior utilized to compute the at least one baseline; and
determining if a quality learning condition has been met.

30. The system of claim 29, wherein the determining if a quality learning condition includes checking if a measured rate-invariant attribute is higher than a rate-invariant quality threshold and a measured rate-based attribute is higher than a rate-based quality threshold.

31. The system of claim 30, further comprising:
determining that the baseline cannot be established for the protected entity when the at least one computed baseline learned has not met at least one quality learning condition.

32. The system of claim 19, wherein building the set of baselines further comprises:
building a set of baseline paraphrase buffers (BPBFs) from at least one validated baseline, wherein each BPBF represents a normal behavior of a paraphrase.

33. The system of claim 19, wherein the paraphrase includes at least one paraphrase value, wherein a paraphrase value represents an applicative attribute in an application-layer transaction.

34. The system of claim 19, wherein application-layer transactions include any one of: HTTP requests, HTTP responses, HTTPs requests, and HTTPs responses.

35. The system of claim 34, wherein application-layer transactions include samples of the actual HTTP requests, their corresponding HTTP responses, wherein a sampling rate of the actual HTTP requests differs as a function of the protected entity incoming traffic volumes.

36. The system of claim 19, wherein the attack-safe baselines are utilized for the characterization and mitigation of application layer flood denial-of-service (DDoS) attacks carried by attackers utilizing advanced application layer flood attack tools.

37. A non-transitory computer-readable medium storing a set of instructions for learning attack-safe baselines, the set of instructions comprising:
one or more instructions that, when executed by one or more processors of a device, cause the device to:
receive application-layer transactions directed to a protected entity;
measure values of a rate-based attribute and a rate-invariant attribute from the received application-layer transactions;
determine, based on the measured rate-based attribute, if the received application-layer transactions represent a normal behavior;
compute at least one baseline using application-layer transactions determined to represent the normal behavior;
validate the at least one computed baseline using the measured rate-invariant attribute and rate-based attribute; and
build a set of baselines based on the at least one validated baseline, wherein the set of baselines are utilized for characterization of DDoS attacks.
